(19) United States
(12) Patent Application Publication
(10) Pub. No.: US 2025/0361164 A1
(43) Pub. Date: Nov. 27, 2025

(54) RECOVERY OF HIGH-QUALITY FERTILIZER PRODUCTS FROM WASTEWATER

(71) Applicant: Kansas State University Research Foundation, Manhattan, KS (US)

(72) Inventors: Prathap Parameswaran, Manhattan, KS (US); Arvind Damodara Kannan, Manhattan, KS (US)

(21) Appl. No.: 19/112,024

(22) PCT Filed: Sep. 19, 2023
(86) PCT No.: PCT/US2023/074540

§ 371 Date: Mar. 14, 2025

Related U.S. Application Data
(60) Provisional application No. 63/407,936, filed on Sep. 19, 2022.

(51) Int. Cl. C02F 3/28; C02F 1/20; C02F 1/52; C02F 1/66; C02F 9/00; C02F 101/10; C02F 103/26

(52) U.S. Cl. CPC C02F 3/2853; C02F 1/20; C02F 1/5236; C02F 1/66; C02F 9/00; C02F 2101/105; C02F 2103/26; C02F 2303/00

(57) ABSTRACT

Methods and systems for recovering nutrient-enriched products from wastewater are provided. Liquid permeate streams recovered from a membrane-type bioreactor may be further treated to remove carbonate species, and then contacted with at least one calcium-containing coagulant. The resulting solids-containing product may be enriched in one or more nutrients, such as phosphorous, and can be used in subsequent applications. such as fertilizers. The resulting liquid stream may also be treated to provide a treated water stream. Methods and systems described herein provide energy-efficient, sustainable processes for treating wastewater and recovering valuable products therefrom.

### CROSS-REFERENCE TO RELATED APPLICATIONS

This patent application claims the priority benefit to U.S. Provisional Patent Application No. 63/407,936, filed Sep. 19, 2022. the contents of which are incorporated by reference herein.

### FEDERALLY SPONSORED RESEARCH/DEVELOPMENT PROGRAM

This invention was made with government support under Grant No. DE-EE0009504 awarded by the United States Department of Energy. The United States government has certain rights in the invention.

### FIELD OF THE INVENTION

This invention relates to methods for recovering one or more valuable products from wastewater, including, for example, nutrients that can be used in or as fertilizer components.

### BACKGROUND

Phosphorus, a non-renewable resource, is an essential macronutrient that supports all life forms and is used extensively in a variety of applications such as fertilizers, soft drinks, pharmaceuticals, biomaterials, and flame retardants. The main source of phosphorus for societal use is from the mining of phosphate rock. Such mineral phosphate rock reserves are predominantly located in a small number of countries, which increases supply chain dependency and impact on global food security. While mineral fertilizers are essential for agriculture and food production, not all the applied nutrients are utilized by plants and, as a result, a large proportion is wasted or lost to the environment. Such fertilizer nutrient losses increase agricultural costs. waste energy, negatively impact global climate, and pollute the environment, thereby affecting the sustainability of modern agriculture.

On the other hand, there is great potential to recover nitrogen, phosphorus, and other value-added minerals from wastewater through appropriate treatment technologies. Currently, the mainstream wastewater treatment is focused on nutrient removal rather than beneficial recovery. Current treatment methods for phosphorus removal from wastewater can be categorized as physical, biological, and chemical removal technologies. Physical technologies include adsorption, sand filtration for particulate phosphorus removal, ion exchange, and membrane filtration. Chemical removal technologies include chemical precipitation and crystallization, electrochemical and bio-electrochemical systems, as well as photosynthetic processes.

Biological technologies include enhanced biological phosphorus removal (EBPR), photosynthetic microbes immobilized on cellulose, ceramic, or gel carriers, and phosphate binding proteins. Although biological methods can achieve phosphorus removal efficiencies greater than 95%, these have certain limitations. Inability to treat wastewater with very high phosphorus concentration, the need for skilled manpower, and system operational instability make it challenging to employ such techniques to remove phosphorous, particularly at locations with stringent requirements for phosphorus concentrations in the treated water effluent from the facility.

For these reasons, biological phosphorus removal is often implemented along with chemical precipitation in order to can achieve very low effluent phosphorus concentrations. Precipitation by metal salts and lime addition, crystallization, coagulation, and flocculation are the most common chemical technologies. Chemical precipitation of phosphorus from wastewater is achieved by the addition of metal salts of iron, magnesium, and calcium to form mineral precipitates such as struvite (Mg·NH₄·PO₄·6H₂O), vivianite (Fe₃(PO₄)₂.8H₂O), and calcium phosphates including Hydroxyapatite, or “HAP,” (Ca₁₀(PO₄)₆(OH)₂), Brushite (CaHPO₄), and amorphous calcium phosphate (Caₓ(PO₄)_{y}*nH₂O). However, little to none of the chemically recovered phosphorus is amenable to beneficial reuse for diverse applications.

One emerging technology for nutrient recovery from wastewater streams is the anaerobic membrane bioreactor (AnMBR), which has shown promise for energy positive treatment of wastewater. Anaerobic membrane bioreactor (AnMBR) treatment of wastewater offers the benefit of simultaneous recovery of both water and energy, along with the potential for mobilizing nutrients for subsequent controlled capture of nitrogen (as ammonium) and phosphorus (as orthophosphate) using different techniques such as coagulation, flocculation, chemical precipitation, and ion exchange. Recent studies have shown that chemical addition can be highly effective for phosphate removal from AnMBR treated municipal wastewater permeate. Factors including total alkalinity, pH, presence of impurities such as dissolved organic matter (humic and fulvic acids) and interfering ions such as carbonate (CO₃²⁻), aluminum (Al³⁺), magnesium (Mg²⁺) affect final fertilizer product quality and purity along with other non-specific product formation (CaCO₃ or MgCO₃). Thus, in these systems, the composition of the treated wastewater significantly influences the type and quality of nutrient products recovered from the wastewater. This makes the possibility of use of these recovered products as fertilizers inconsistent and uncertain.

Further, there currently exist several commercial-scale chemical technologies for phosphorus recovery from municipal and industrial wastewaters. Most of these technologies produce struvite as the final product. Other large scale technologies produce calcium phosphate. While struvite is the most common phosphate fertilizer product recovered from wastewater, it is limited by several shortcomings such as high operational costs, high energy consumption, and large footprint of the recovery technologies. In addition, struvite is marketed solely as a slow-release fertilizer and cannot be used for other applications. However, calcium phosphates recovered from wastewater have a phosphorus content comparable to mined rock phosphates, which allow their application as direct fertilizers or as raw materials for the fertilizer industry. The quality of the recovered phosphorus product is often mired by the quality of the waste stream from which it is captured, lowering its efficacy when compared to commercial fertilizer.

The phosphorous products recovered from wastewater by commercial technologies that are currently marketed as fertilizer or used in fertilizer products have generally consistent phosphorous content and usually less-than-desirable solubility and bioavailability. The processes used to produce them are typically inefficient in terms of both energy and cost, as well as having potentially negative impacts on the environment.

Thus, a need exists for a phosphorous-based fertilizer product (or precursor thereto) that can be recovered from wastewater that has desirable (and, ideally, controllable) levels of phosphorous, as well as desired degrees of solubility and bioavailability. It would be desirable for such a product to have uses other than fertilizer and for the process itself to be tailored to produce different phosphorous-based products. Further, it would be desirable for the process for making such products be energy and cost efficient, as well as having minimal impact on the environment.

### SUMMARY

In one aspect, the present technology involves a method for recovering one or more phosphorous-containing products from a wastewater stream, the method comprising: (a) treating a wastewater stream in a membrane bioreactor to provide a nutrient-containing liquid permeate stream; (b) adjusting the pH of at least a portion of the liquid permeate stream in a pH adjustment zone to provide a pH-adjusted liquid permeate stream; (c) aerating at least a portion of the pH-adjusted liquid permeate stream with a stripping gas in an aeration zone to provide a carbon dioxide containing off-gas stream and an aerated permeate stream; and (d) precipitating at least one nutrient from the aerated permeate stream in a solids recovery zone to thereby provide a phosphorous-containing recovered nutrient product and a residual liquid stream.

In one aspect, the present technology involves a method for recovering one or more phosphorous-containing products from a wastewater stream, the method comprising: (a) treating a phosphorous-containing liquid permeate stream to provide a carbonate-depleted permeate stream, wherein the permeate stream is obtained by filtering wastewater obtained from an agricultural, industrial, and/or municipal source; (b) adding at least one calcium-containing coagulant to the carbonate-depleted permeate stream to provide a phosphorous-containing recovered nutrient product (RNP) and a residual liquid stream; and (c) further treating the residual liquid stream in a water treatment zone to provide a treated water stream.

In one aspect, the present technology involves a wastewater processing facility for recovering at least one phosphorous-containing product from a stream of wastewater, the system comprising: a wastewater source; an anaerobic membrane bioreactor for processing a stream of wastewater from the wastewater source, the membrane bioreactor being in fluid flow communication with the wastewater source, wherein the membrane bioreactor is configured to receive the stream of wastewater, wherein the membrane bioreactor comprises a membrane configured to permit at least a portion of the wastewater introduced into the membrane bioreactor to pass therethrough thereby providing a permeate, and wherein the membrane bioreactor is configured to discharge at least a portion of the permeate from the membrane bioreactor; a pH adjustment zone for altering the pH of the permeate, the pH adjustment zone being in fluid flow communication with the membrane bioreactor, wherein the pH adjustment zone is configured to receive the permeate stream and to discharge a pH adjusted permeate stream; an aeration zone for removing dissolved carbon dioxide from at least a portion of the pH adjusted permeate stream, the aeration zone being in fluid flow communication with the pH adjustment zone, wherein the aeration zone is configured to receive at least a portion of the pH adjusted permeate stream and to discharge an aerated permeate stream, wherein the aeration zone is configured to receive a stripping gas and pass the stripping gas through at least a portion of the pH adjusted permeate stream to remove at least a portion of dissolved carbon dioxide gas, and wherein the aeriation zone is configured to discharge a carbon dioxide-containing off gas stream from the aeration zone; and a solids recovery zone for removing one or more nutrient solids from the aerated permeate stream via addition of at least one coagulant, the solids recovery zone being in fluid flow communication with the aeration zone, wherein the solids recovery zone is configured to receive at least a portion of the aerated permeate stream and discharge a residual liquid stream and a phosphorous-containing recovered nutrient product.

In one aspect, the present technology involves a nutrient product composition recovered from a wastewater stream, the composition comprising: at least 50 weight percent of amorphous calcium phosphate. based on the total weight of the composition; and not more than about 5 weight percent of nitrogen or other nutrients originating from a wastewater stream, wherein the composition has each of the following properties (i) through (iv): (i) a total phosphorous content of at least 5 weight percent; (ii) a calcium-to-phosphorous molar ratio of less than about 2.5; (iii) a citric acid solubility (in 2% citric acid) of at least about 2 weight percent; and (iv) an XRD pattern that shows no clear calcite peak.

### BRIEF DESCRIPTION OF THE DRAWINGS

FIG. 1 is a schematic process flow diagram illustrating the main steps/zones of a wastewater processing facility configured to treat the permeate stream withdrawn from a membrane bioreactor to obtain a recovered nutrient product (RNP) and a treated water stream;

FIG. 2a is a graphical representation of the phosphorous removal efficiency of a first set of several experimental coagulation trials conducted as described in Example 2;

FIG. 2b is a graphical representation of the phosphorous removal efficiency of a second set of several experimental coagulation trials conducted as described in Example 2;

FIG. 3a is a graphical representation of the phosphorous removal efficiency of a first set of several experimental coagulation trials conducted as described in Example 3;

FIG. 3b is a graphical representation of the phosphorous removal efficiency of a second set of several experimental coagulation trials conducted as described in Example 3;

FIG. 4a is a graphical representation of the phosphorous removal efficiency of a first set of several experimental coagulation trials conducted as described in Example 4;

FIG. 4b is a graphical representation of the phosphorous removal efficiency of a second set of several experimental coagulation trials conducted as described in Example 4;

FIG. 5a is the XRD pattern for samples of recovered nutrient product obtained by treating altered swine wastewater permeate with varying calcium-to-phosphorous ratios as described in Example 5; and

FIG. 5b is the XRD pattern for samples of recovered nutrient product obtained by treating unaltered swine wastewater permeate with varying calcium-to-phosphorous ratios as described in Example 5.

### DETAILED DESCRIPTION

According to aspects of the present technology, high quality phosphorus-based fertilizer products, including calcium phosphates and/or struvite, can be efficiently recovered from wastewater with product phosphorous content in the range of 7 to 12 weight percent, or even 11 to 15 weight percent, which is at least comparable to, and likely higher than, other commercial wastewater derived products. Processes described herein also provide concomitant water for reuse. In some aspects, the present technology includes removal of the carbonate species from a treated permeate stream, using through aeration and pH change, which then selects against undesirable calcite and other non-specific products. Subsequently, the carbonate can be redistributed to the residual water after the phosphorous recover step to thereby remove any residual hardness and perform a final pH adjustment.

By adjusting the wastewater permeate withdrawn from the membrane reactor by, for example, pH adjustment and aeration, an improved nutrient product (having phosphorous levels comparable to mineral phosphates) is provided, In addition, the alkaline pH of the final liquid permeate stream can eliminate the need for disinfection before spreading the product on land or reusing the treated water as non-potable water,

Further, the quality of the final liquid permeate after the solids recover step can be further improved by recycling at least a portion of the CO₂ stripped from the pH-adjusted permeate during aeration to remove residual calcium hardness in the water to provide a treated water stream suitable for discharge. This step of recycling at least a portion of the CO₂, along with efficient recovery of energy from the AnMBR as biogas, helps offset carbon emissions from the treatment facility, as well as reduce the energy footprint of the nutrient recovery process. This both reduces environmental impact and improves economic viability. Overall, embodiments of the present technology provide a sustainable nutrient recovery platform that enables tailored recovery of high-quality nutrients despite fluctuations in influent wastewater properties or compositions.

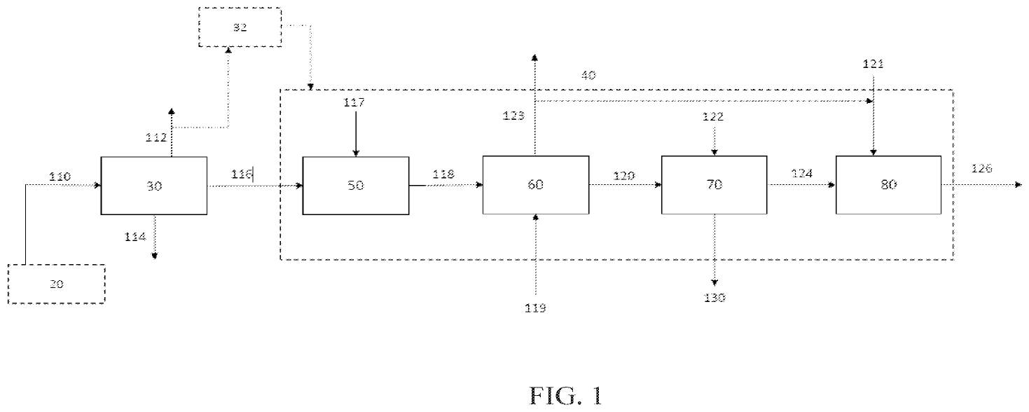

Turning initially to FIG. 1, a schematic flow diagram illustrating the main steps/zones of a wastewater processing facility 10 configured according to embodiments of the present technology is provided. Wastewater processing facility 10 may be configured to beneficially recover one or more valuable products from the incoming wastewater including, but not limited to, phosphorous and other nutrients. Simultaneously, wastewater processing facility 10 may also produce a treated or purified water stream suitable for most potable uses, as well as one or more recovered process streams that can be used directly or indirectly (e.g., as a source of energy) within the process.

As shown in FIG. 1, the wastewater stream may originate from a wastewater source 20. The wastewater source 20 can be any source capable of supplying wastewater to the system. In some embodiments, the wastewater source may be agricultural, such that the wastewater stream 110 comprises agricultural wastewater. An example of agricultural wastewater includes permeate from swine or other livestock (e.g., collected from a lagoon or other waste structure or facility), or it could include wastewater collected from other agricultural activities, such as irrigation. In other embodiments, the wastewater source 20 may be a municipal and/or industrial source so that the wastewater stream 110 comprises municipal and/or industrial wastewater. In some embodiments, the wastewater stream 110 may be a combination of two or more of municipal, industrial, and agricultural wastewater. Wastewater source 20 may comprise a single source or it can include two or more sources of the same or different types.

The exact composition of the wastewater can vary, but in some embodiments, it may have one or more characteristics or components within the ranges shown in Table 1, below.

TABLE 1
Potential Compositional Ranges for Wastewater
Treated in the Membrane Bioreactor

| Component | Broad | Intermediate | Narrow |
|---|---|---|---|
| pH | >6.75 | >7.25 | >7.5 |
| TAN (mg/L, as N) | 100 to 1000 | 200 to 800 | 350 to 750 |
| COS (mg/L, sCOD) | 500 to 10,000 | 1000 to 7500 | 1500 to 7500 |
| TSS (mg/L) | 1000 to 50,000 | 2500 to 25,000 | 5000 to 15,000 |
| Phosphate (mg/L) | 10 to 150 | 20 to 100 | 25 to 75 |

As shown in FIG. 1, the wastewater stream 110 may be introduced into a wastewater processing reactor (such as, for example, a membrane bioreactor 30) configured to separate the wastewater into two or more streams including, for example, a biogas stream 112, a sludge stream 114, and a liquid permeate stream 116. The liquid permeate stream 116 may be rich in one or more nutrients, such as, for example, nitrogen-containing compounds and/or phosphorous-containing compounds. One or more of these compounds may be present in an amount of at least about 0.001, at least about 0.005, at least about 0.010, at least about 0.05, at least about 0.10, at least about 0.50, or at least about 1 weight percent and/or not more than about 5, not more than about 2, not more than about 1.5, not more than about 1, not more than about 0.5, not more than about 0.25, not more than about 0.10, or not more than about 0.05 weight percent, based on the total weight of the stream. Other components may also be present in smaller or trace amounts, such as less than about 1000 ppm, less than about 500 ppm, less than about 250 ppm, or less than about 100 ppm by weight.

In some cases, the processing reactor may be an anaerobic membrane bioreactor (AnMBR). Anaerobic membrane bioreactors (AnMBRs) combine anaerobic treatment with an ultrafiltration membrane in a wastewater treatment process. In general, AnMBRs utilize a membrane to separate solids (i.e., sludge) from incoming wastewater via a membrane, and then utilize bacteria to anaerobically process the sludge. AnMBRs have a smaller physical footprint than other reactors, and can achieve at least about 75, at least about 80, at least about 85, or at least about 90 percent chemical oxygen demand (COD) removal under steady state conditions.

The gaseous byproducts formed during the anaerobic treatment can be removed from the reactor in the biogas stream 112. Biogas stream 112, which may comprise at least about 50, at least about 60, or at least about 75 mole percent methane, can be further processed to generate energy in an energy generation step/zone 32, as generally shown in FIG. 1. Such energy can be generated in any suitable manner, including, but not limited to, combustion and/or heating of at least a portion of the biogas stream 112. The energy generated may be in the form of heat, electricity, and/or steam. In some cases, as generally illustrated in FIG. 1, at least a portion of the energy generated from the biogas stream 112 may be reintroduced into one or more locations within the nutrient recovery zone 40 of the wastewater processing facility 10, wherein it may be utilized as energy needed to carry out a portion of the process performed therein. Thus, the potential for recovery and reuse of energy generated from the biogas stream 112 enhances the energy efficiency and sustainability of the wastewater processing facility 10.

As shown in FIG. 1, the nutrient-rich liquid permeate stream 116 separated from the sludge 114 can be withdrawn from the membrane bioreactor 30 and may then be introduced into a nutrient recovery zone 40. Within nutrient recovery zone 40, the liquid permeate stream 116 may be treated to recover one or more nutrients therefrom, while additionally providing a stream of treated water. For example, the liquid permeate stream may be treated to remove carbonate compounds therefrom and then further treated to provide a recovered nutrient product (RNP) and a treated water stream.

The recovered nutrient product (RNP) may include at least about 2, at least about 4, at least about 5, at least about 7, at least about 10, at least about 15 and/or not more than about 50, not more than about 40, not more than about 30, or not more than about 25 weight percent of one or more valuable components that can be reused in one or more diverse applications. In some cases, the liquid permeate stream 116 may be treated to recover phosphorous, typically in the form of calcium phosphate and/or struvite. The liquid permeate stream 116 withdrawn from the bioreactor 30 may have a component or characteristic within one or more of the ranges summarized in Table 2, below.

TABLE 2
Potential Compositional Ranges for Liquid Permeate

| Component | Broad | Intermediate | Narrow |
|---|---|---|---|
| COD (mg/L) | 200 to 2000 | 300 to 1000 | 350 to 750 |
| Zinc, Zn (mg/L) | <5 | <2 | <1 |
| Ammonium, NH₄—N (mg/L) | 300 to 1000 | 400 to 750 | 450 to 600 |
| Nitrate, NO₃—N (mg/L) | <0.075 | <0.05 | <0.01 |
| Chloride, Cl (mg/L) | 200 to 1500 | 350 to 800 | 400 to 550 |
| Aluminum, Al (mg/L) | <0.075 | <0.05 | <0.01 |
| Phosphorus, P (mg/L) | 10 to 500 | 25 to 300 | 30 to 100 |
| Calcium, Ca (mg/L) | 10 to 1000 | 25 to 750 | 40 to 150 |
| Magnesium, Mg (mg/L) | 5 to 350 | 10 to 200 | 15 to 75 |
| Sodium, Na (mg/L) | 1 to 250 | 2 to 100 | 5 to 50 |
| Potassium, K (mg/L) | 100 to 2000 | 250 to 1000 | 350 to 750 |
| Copper, Cu (mg/L) | <0.075 | <0.05 | <0.01 |
| Iron, Fe (mg/L) | <0.5 | <0.1 | <0.075 |
| Manganese, Mn (mg/L) | <0.25 | <0.10 | <0.075 |
| Sulfur, S (mg/L) | 5 to 350 | 10 to 175 | 15 to 75 |
| pH | >6.5 | >7.0 | >7.2 |
| Alkalinity mg/L as CaCO₃ | 500 to | 1000 to | 2250 to |
| | 10,000 | 7500 | 5000 |

Unless otherwise noted herein, total phosphorus is measured with HACH TNT 844 and TNT 845 kits (concentration range 0.5 to 5 mg/L-P and 2 to 20 mg/L-P, respectively) using the HACH DR 3900 spectrophotometer (Loveland, CO, USA). Total chemical oxygen demand (TCOD) was analyzed using HACH TNT 822 kits (20 to 1500 mg/L). pH was measured using Fisherbrand™ accumet™ AB150 pH Benchtop Meters. Total Alkalinity was measured using HACH TNT 870 kit (25-400 mg/L CaCO₃). Initial permeate Ca²⁺ and Mg²⁺ concentrations were measured using the Dionex ICS 5000+ Ion chromatography instrument. Chemical analyses of certain other components including Zn, Cl, Al, Cu, Fe, Mn, and S in the permeate before coagulant addition were performed at the Soil Testing Lab at Kansas State University Agronomy department.

Referring again to FIG. 1, the resulting treated liquid permeate 116 withdrawn from the membrane bioreactor 30 may be generally free of particulate matter (i.e., it may have a total suspended solids (TSS) content of not more than 1000, not more than 500, not more than 100, not more than 50, or not more than 10 mg/L). In some cases, the liquid permeate 116 may be suitable for reuse in several applications, such as, for example as non-potable water for various end uses. This stream 116 is also rich in nutrients such as nitrogen and phosphorous, which can be recovered, according to embodiments of the present technology, in a nutrient recovery zone 40, as shown in FIG. 1.

In some embodiments, as illustrated generally in FIG. 1, the nutrient recovery zone 40 can include a pH adjustment step/zone 50, wherein the liquid permeate stream 116 from the bioreactor 30 may undergo a pH adjustment. In some cases, the pH of the liquid permeate stream 116 introduced into the pH adjustment step/zone 50 can be at least about 6.5, at least about 6.75, at least about 6.8, at least about 6.9, at least about 7, at least about 7.1, at least about 7.25, at least about 7.3, at least about 7.4, or at least about 7.5 and/or not more than about 9, not more than about 8.75, not more than about 8.5, not more than about 8, not more than about 7.5, or not more than about 7.3, and the pH adjustment step may lower the pH to a pH of not more than about 6, not more than about 5.5, not more than about 5, or not more than about 4.5,

In some embodiments, the pH of the liquid permeate stream 116 may be lowered through addition of an acid 117, such as a mineral acid. Examples of suitable acids include, but are not limited to, concentrated sulfuric acid, hydrochloric acid, nitric acid, phosphoric acid, and combinations thereof. The concentration and volume of acid added are sufficient to achieve the final pH as described herein. Alternatively, the liquid permeate stream 116 may be fermented in a modified anaerobic membrane reactor (that includes a fermentation zone or area) thereby providing a fermented permeate with a pH of not more than about 6, not more than about 5.5, or not more than about 5.

Although not wishing to be bound by theory, it is believed that in performing this pH reduction, carbonate species present within the liquid permeate 116 may be converted to carbonic acid and then to carbon dioxide gas. Then, as shown in FIG. 1, the pH-adjusted liquid permeate 118 from the pH adjustment step/zone 50 may be introduced or subjected to an aeriation step/zone 60. Although shown in FIG. 1 as comprising two separate zones (or vessels), in some cases, the pH adjustment step 50 and the aeration step 60 can be performed in a single zone or even single vessel. In some embodiments when the liquid permeate stream withdrawn from the membrane reactor is a fermented permeate stream having a pH less than 6, the pH adjustment zone (e.g., fermentation zone) may be located within or near the membrane bioreactor 30.

During the aeration step 60, a stream of stripping gas 119 is passed through the pH adjusted solution to strip out at least a portion of the (dissolved) carbon dioxide gas present in the pH adjusted permeate stream. The stripping gas 119 can be any suitable gas such as, for example, nitrogen or air. The aeration or stripping step 60 can be performed for any amount of time needed to remove all, or a portion, of the carbon dioxide from the liquid. For example, the aeration step 60 can be carried out for an amount of time sufficient to reduce the amount of dissolved carbon dioxide in the pH adjusted liquid permeate by at least about 50, at least about 60, at least about 70, at least about 75, at least about 80, at least about 85, at least about 90, or at least about 95 percent, based on the amount of dissolved carbon dioxide in the pH adjusted permeate stream.

In some cases, the aeration can be carried out for a period of at least about 5, at least about 10, at least about 20 hours and/or not more than about 40, not more than about 30, or not more than about 25 hours. The aeration may be sufficient to complete the stripping of at least 80 percent, at least 85 percent, at least 90 percent, at least 95 percent, or at least 99 percent of the CO₂ present in the pH-adjusted stream, and subsequent steps may remove at least about 80 percent, at least about 85 percent, at least about 90 percent, at least about 95 percent, or at least about 97 percent of the phosphorous from the remaining liquid, based upon the pH value after acid addition and/or the concentration of competing carbonate ions still present in the solution.

In some embodiments, following CO₂ stripping, the pH-regulated, aerated permeate 120 comprises a CaCO₃ level of no more than 200, no more than 150, no more than 100, no more than 80, or no more than 70 mg/L CaCO₃. The pH of this stream 120 can be at least about 6.75, at least about 6.8, at least about 6.9, or at least about 7 and/or not more than about 8, not more than about 7.9, not more than about 7.8, not more than about 7.75, not more than about 7.6, not more than about 7.5, not more than about 7.4, not more than about 7.3, or not more than about 7.25.

In some embodiments, at least a portion of the carbon dioxide off gas 123 discharged from the aeration step/zone 60 may be captured (e.g., from the headspace of the vessel in which the aeration occurs) and sustainably repurposed. For example, in some embodiments, at least a portion of this stream 123 may be used in polishing of the finished water from the membrane reactor to adjust its pH and control the water hardness, as discussed in greater detail below.

Next, as shown in FIG. 1, the aerated liquid permeate stream 120 from the aeration step/zone 60 may be further treated in a solids recovery step/zone 70, wherein at least a portion of the nutrients or other valuable components remaining in the liquid permeate can be recovered from the liquid, leaving a residual, treated water stream. In some cases, as shown in FIG. 1, a coagulant 122 may be added to prompt precipitation of the nutrient or other valuable component (which may be at least partially dissolved in the liquid), which can then be recovered in a recovered nutrient product 124.

Any suitable coagulant can be used. In some cases, the coagulant 122 comprises a calcium-containing compound, such as, for example, calcium oxide, calcium chloride, and combinations thereof. In some cases, the coagulant can include at least about 75, at least about 80, at least about 85, at least about 90, at least about 95, or at least 99 percent of a single calcium-containing compound such as calcium oxide or calcium chloride. In some cases, the coagulant may include at least about 99, at least about 99.5, or at least about 99.9 weight percent calcium oxide or calcium chloride. According to some embodiments, the coagulant comprises calcium oxide or calcium chloride and may include less than about 5, less than about 2, less than about 1, less than about 0.5, or less than about 0.1 weight percent of any components other than calcium oxide or calcium chloride.

In other cases, the coagulant can be a mixture of two or more calcium-containing coagulants, such that one (or each) is present in an amount of at least about 10, at least about 15, at least about 20, at least about 25, at least about 30, at least about 35, at least about 40, or at least about 45 percent and/or not more than about 85, not more than about 80, not more than about 75, not more than about 70, not more than about 65, not more than about 60, or not more than about 55 percent, based on the total amount of calcium-containing coagulant. When two or more compounds are present, they may be present in similar or different amounts. In some embodiments, the coagulant is a mixture of calcium oxide and calcium chloride, wherein each is present in an amount of between 40 to 60 weight percent. For example, the coagulant may be a blend of 50 weight percent calcium oxide and 50 weight percent calcium chloride. The coagulant may comprise, consist essentially of, or consist of calcium oxide, calcium chloride, or a mixture of calcium oxide and calcium chloride.

According to some embodiments, a calcium-containing coagulant (e.g., calcium oxide) is added to the aerated permeate 120 at different stoichiometric doses of Ca:P in order to produce a precipitate comprising calcium phosphate. For example, in one or more embodiments, the calcium-containing coagulant 122 (e.g., CaO) is added to the pH-regulated, aerated permeate stream 120 such that the molar ratio of calcium to phosphorous (Ca:P) in the mixture (within the solids recovery zone 70) is at least about 2:1, at least about 4:1, at least about 5:1, at least about 6:1, at least about 8:1, or at least about 10:1 and/or not more than about 20:1, not more than about 18:1, not more than about 15:1, not more than about 12:1, or not more than about 10:1, or in the range of from 2:1 to 20:1 or 4:1 to 18:1, or 5:1 to 12:1, or 6:1 to 10:1.

Although not wishing to be bound by theory, it is believed that the loss of carbonate alkalinity in the pH-regulated, aerated permeate 120 results in higher availability of the Ca²⁺ ions to participate in phosphate precipitation reactions. Further, the buffering capacity of the altered permeate 120 is significantly reduced in the absence of carbonate alkalinity, making it easier for calcium oxide to reach alkaline conditions.

It is within the scope of the present technology for other coagulants besides CaO to be employed in the coagulation, flocculation, and precipitation of phosphorus species from the permeate; however, in some cases, CaO may be a preferred coagulant due to its ability to achieve alkaline conditions in the permeate. More particularly, when the coagulant 122 includes CaO, the pH of the solution within the solids recovery zone or step 70 can be raised to at least about 7.25, at least about 7.3, at least about 7.4, at least about 7.5, at least about 7.6, at least about 7.75, at least about 8, at least about 8.5, or at least about 9.

The coagulation, flocculation, and precipitation of phosphates, e.g., calcium phosphate, from the pH-regulated, aerated permeate stream 120 in the solids recovery zone 70 can achieve at least about an 80 percent, at least about an 85 percent, at least about a 90 percent, at least about a 95 percent, or at least about a 97 percent reduction in phosphorus levels within the final permeate (e.g., the residual liquid stream 124 shown in FIG. 1) as compared to the initial liquid permeate taken from the anaerobic membrane bioreactor and/or introduced into the nutrient recovery zone 40 (e.g., the liquid permeate stream 116 shown in FIG. 1). In one or more embodiments, the residual phosphorus concentration in the final permeate (e.g., residual liquid stream 124) is no more than 5, no more than 4, no more than 3, no more than 2.5, no more than 2, no more than 1.5, or no more than 1.35 milligrams of phosphorous per L (mg P/L).

As shown in FIG. 1, at least a portion of the residual liquid stream (or final permeate stream) 124 withdrawn from the solids recovery step/zone 70 can be introduced into a water treatment step/zone 80, wherein it may undergo additional processing steps to provide a final treated water stream 126. In some embodiments, the additional treatment steps may include a recarbonation step, wherein the residual liquid stream 124 from the solids recovery zone 70 can be contacted with at least one carbon dioxide-containing stream 121. The addition of CO₂ at this stage lowers the pH of the final treated water after nutrient capture and provides an opportunity for residual hardness removal by precipitation of calcium carbonate through reaction with residual calcium and CO₂. Thus, a nutrient-free, high-quality, treated permeate stream 126 can then be recovered with additional removal of organics (measured as chemical oxygen demand, or COD) as compared to the coagulation-flocculation-sedimentation process conducted in solids recovery zone 70.

In one or more embodiments, the final treated water stream (or permeate) 126 comprises a chemical oxygen demand of less than 700, less than 650, less than 600, less than 575, less than 550, or less than 530 mg/L. The pH of the final treated water stream 126 can be at least about 6.5, at least about 6.6, at least about 6.75, at least about 6.8, or at least about 6.9 and/or not more than about 8, not more than about 7.9, not more than about 7.8, not more than about 7.75, not more than about 7.7, not more than about 7.6, not more than about 7.5, not more than about 7.4, not more than about 7.3, not more than about 7.25, or not more than about 7.1, or it can be about 7.

In some embodiments, the carbon dioxide-containing gas stream 121 introduced into the water treatment step/zone 80 can include at least a portion of the carbon dioxide-containing off gas stream 123 withdrawn from the aeration step/zone 60. Thus, at least a portion of the carbon dioxide previously stripped from the liquid permeate during the aeration step 60 may be used for re-carbonation in the water treatment step or zone 80. This also increases the efficiency and sustainability of the facility 10 shown in FIG. 1.

As shown in FIG. 1, a recovered nutrient product (RNP) 130 may also be removed from the solids recovery step or zone 70. The recovered nutrient product 130 can be formed by the coagulation, flocculation, and precipitation of one or more nutrients from the liquid permeate in the solids recovery step/zone 70 and can be a solids-containing stream (that may or may not include residual liquid).

The RNP can comprise calcium and phosphorus and, in particular, may comprise calcium phosphate. In some embodiments, the RNP may comprise at least about 20, at least about 25, at least about 30, at least about 35, at least about 40, at least about 45, at least about 50, at least about 55 and/or not more than about 95, not more than about 90, not more than about 85, not more than about 80, not more than about 75, not more than about 70, not more than about 65, or not more than about 60 weight percent of calcium phosphate, based on the total weight of the RNP. The calcium phosphate can comprise amorphous calcium phosphate. Struvite may also be present in some embodiments, while in other embodiments, less than about 5, less than about 2, less than about 1, or less than about 0.5 weight percent of the RNP may include struvite.

In some embodiments, the RNP has a total phosphorous content of at least about 5, at least about 7, at least about 8, at least about 9, at least about 10, or at least about 11 weight percent, and/or not more than about 15, not more than about 14, not more than about 13, not more than about 12, not more than about 11, or not more than about 10 percent by weight, or it can be from 7 to 12 weight percent, or 11 to 15 weight percent, based on the total weight of the RNP. Additionally, or in the alternative, the RNP can comprise calcium (Ca) and phosphorous (P) in a molar ratio of Ca:P of at least about 1.1:1, at least about 1.2:1, at least about 1.3:1, or at least 1.4:1 and/or not more than about 2.5:1, not more than about 2.4:1, not more than about 2.3:1, not more than about 2.25:1, not more than about 2.2:1, not more than about 2.1:1, not more than about 2:1, not more than about 1.95:1, or not more than 1.9:1. In some cases, it may be not more than about 1:2.2, not more than 1.4 to about 1.9, or lower.

Further, in some embodiments, the RNP may have a citric acid solubility (measured in 2% citric acid), as defined in the Examples, of at least about 2, at least about 2.5, at least about 3, at least about 4, at least about 5, at least about 6, at least about 7, at least about 8, at least about 9, or at least about 9.3 percent and/or not more than about 14, not more than about 13, not more than about 12, or not more than about 11.4 percent, or from 7 to 14 percent, from 8 to 13 percent, from 9 to 12 percent, or from 9.3 to 11.4 percent. Citric acid solubilities can correlate with usefulness as a fertilizer product, with compositions having higher citric acid solubilities being more desirable for use as fertilizers or fertilizer components.

At the same time, the RNP may include nitrogen or other nutrients originating from the original wastewater and these may be present in an amount of not more than about 5, not more than about 2, not more than about 1, not more than about 0.5, or not more than about 0.25 weight percent, based on the total weight of the RNP. Additionally, depending on whether the RNP was dried, it may include residual liquid water in an amount of at least about 1, at least about 2, at least about 5, or at least about 10 weight percent and/or not more than about 25, not more than about 20, not more than about 15, or not more than about 12 weight percent, based on the total weight of the RNP. In other cases, when the RNP has been dried, it may include less than about 500, less than about 250, or less than about 100 ppm of water, or a trace amount of water according to the relative humidity of the environment.

According to embodiments of the present invention, at least a portion of the RNP may then be used in a variety of end use applications, such as, for example, as or in fertilizer products, or other applications requiring calcium phosphate.

The treated water stream 126 withdrawn from the water treatment zone 80 can be used as potable water, non-potable water, or may be discharged into a local water body as per appropriate regulations. In some embodiments, this wastewater facility 10 described herein and with regard to FIG. 1 can be retrofit onto an existing wastewater facility, so that the inlet and outlet streams from facility 10 may be joined into one or more stream into, out of, and/or within an existing (or newly constructed) wastewater facility (not shown).

### EXAMPLES

### Example 1—Collection and Testing of Swine Permeate

Swine permeate treated in a lab-scale anaerobic membrane bioreactor was collected during the day of testing from a lab-scale Anaerobic Membrane Bioreactor (AnMBR) located at Kansas State University treating real swine lagoon wastewater. This lab scale AnMBR system had a COD removal efficiency >80% and BOD₅ removal efficiency >95% under steady state conditions. Two permeate samples were collected from the AnMBR during its treatment of swine wastewater (i.e., lagoon water) were collected on two different days. The compositions of each sample were characterized, and the results are provided in Table 3, below.

TABLE 3
Composition of two samples of AnMBR-treated Swine Permeate

| | Sample 1 | Sample 2 |
|---|---|---|
| COD (mg/L) | 658 | 573 |
| Zinc, Zn (mg/L) | 0 | 0 |
| Ammonium, NH₄—N (mg/L) | 584.59 | 587.58 |
| Nitrate, NO₃—N (mg/L) | <.0.01 | <.0.01 |
| Chloride, Cl (mg/L) | 452.34 | 451.78 |
| Aluminum, Al (mg/L) | <0.01 | <0.01 |
| Phosphorus, P (mg/L) | 65.5 | 65 |
| Calcium, Ca (mg/L) | 99.73 | 94.81 |
| Magnesium, Mg (mg/L) | 25.85 | 25.17 |
| Sodium, Na (mg/L) | 14.23 | 15.07 |
| Potassium, K (mg/L) | 551.21 | 556.11 |
| Copper, Cu (mg/L) | <0.01 | <0.01 |
| Iron, Fe (mg/L) | 0.07 | 0.03 |
| Manganese, Mn (mg/L) | 0.05 | 0.05 |
| Sulfur, S (mg/L) | 23.01 | 29.66 |
| pH | 7.52 | 7.57 |
| Alkalinity mg/L as CaCO₃ | 3380 | 2950 |

As shown in Table 3, above, the swine water permeate includes both ammonia-based nitrogen and phosphorous. The following examples provide further details regarding the recovery and characteristics of phosphorous from similar samples of swine wastewater permeate from an AnMBR.

### Examples 2 & 3—Coagulation Experiments

Several coagulation experiments were conducted using the swine permeate collected from the lab scale AnMBR system described in Example 1. These experiments were performed by mixing 1-L beakers filled with the swine wastewater permeate solution using a Phipps & Bird 6-paddle jar stirrer (Model No. 7790-910). Incremental dosages of coagulant were added, with the specific amount targeting a certain Ca:P ratio. The solution was rapidly mixed during addition of the coagulant at 100 rpm for 2 minutes. Thereafter, the solution was mixed at a slower rate—i.e., 30 rpm for 20 minutes. Then the mixing was stopped and the solution was permitted to settle for 30 minutes, during which time the precipitated solids collected at the bottom of the beakers. The remaining liquid was decanted to 1-L graduated cylinders for subsequent analysis of sludge settleability.

The solid nutrient-containing materials (e.g., RNP) recovered from each beaker and analyzed to determine both pH and percent phosphorous (P) recovery from the liquid (i.e., (weight of P in initial liquid sample−weight of P in solid RNP)/(weight of P in initial liquid sample)×100%). Each of Examples 2 and 3, below, utilize different parameters of the coagulation experiments and the results of each are discussed in detail below and with regard to the referenced Figures.

### Example 2—Use of a Mixed Coagulant (50:50 Calcium Oxide:Calcium Chloride)

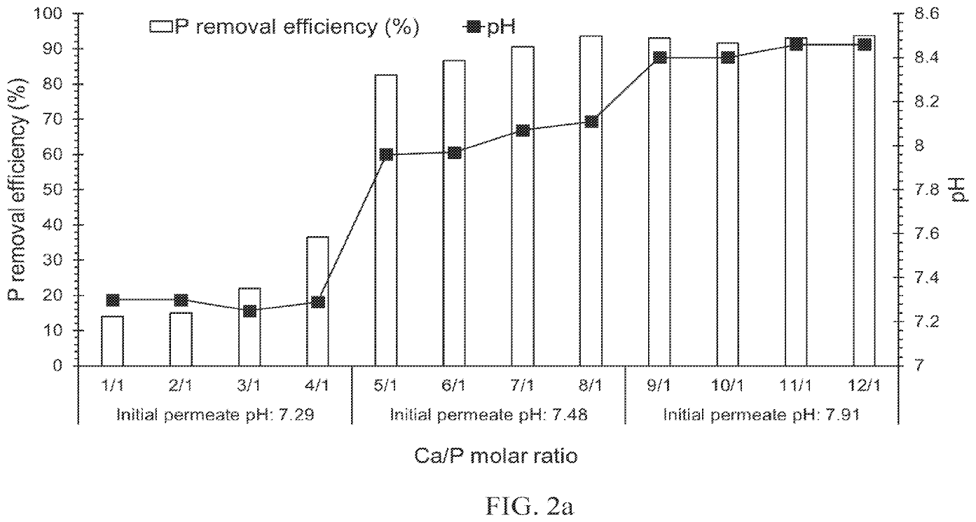

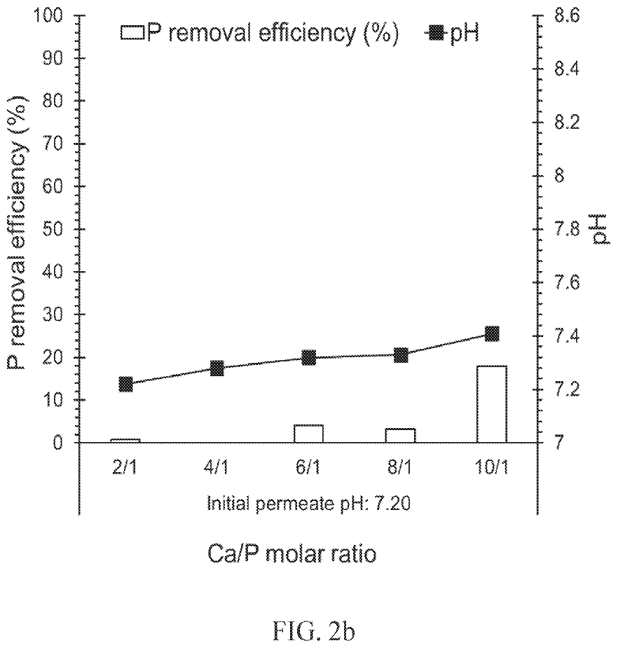

The first set of coagulation experiments utilized Mixed Coagulant, which included a 50:50 weight percent mixture of calcium oxide and calcium chloride. Various amounts of this coagulant were added to the beakers of swine permeate described above to achieve final calcium-to-phosphorous (Ca:P) molar ratios of 1:1 to 12:1 in the mixed solution. The mixtures were permitted to mix, thereby promoting coagulation, flocculation, and precipitation of a nutrient-enriched solids product. As mentioned previously, the pH value and phosphorous removal efficiency were determined by analysis of the solids product. A graphical depiction of the results for this set of experiments is provided in FIG. 2a.

As shown in FIG. 2a, the phosphorous removal efficiencies at lower coagulant doses (i.e., at Ca:P ratios of 1:1, 2:1, 3:1, and 4:1) were 13.9%, 15%, 22%, and 36%, respectively. The removal efficiency at higher doses of coagulant, i.e., starting at a Ca:P ratio of 5:1, reached 82 percent phosphorous recovery, and continued to increase, with the higher Ca:P ratios achieving higher phosphorous recoveries. The maximum phosphorous recovery of 93 percent was achieved when sufficient coagulant was added to achieve an 8:1 Ca:P ratio.

In addition, as shown in FIG. 2a, the phosphorous removal efficiency did not increase any further when the 8:1 Ca:P ratio was increased. Instead, the removal efficiency remained approximately the same as the Ca:P ratio was increased above 8:1. Although the mixed coagulant was able to efficiently remove the phosphorous from the swine wastewater permeate, the need for a higher calcium dose may also be explained by the need to achieve significant apparent supersaturation conditions and induce precipitation within the short duration of the flocculation experiments with the swine wastewater permeate.

A second set of similar trials was conducted again with varying doses of mixed coagulant (i.e., 50:50 mixture of calcium oxide and calcium chloride) to achieve various Ca:P molar ratios. Again, pH of the final solid product and overall percent phosphorous removal efficiency were tested for each Ca:P ratio. The results of this set of experiments are shown in FIG. 2b. As shown by comparison of FIGS. 2a and 2b, the second set of trials provided data inconsistent with the first set. More specifically, the phosphorous removal efficiency in the second set of experiments was negligible or minimal under several different Ca:P conditions (e.g., Ca:P of 2:1, 4:1, 6:1, and 8:1).

However, upon closer review, there is a difference between the first and second sets of experiments. More specifically, as shown in FIG. 2a, the first set of experiments has initial solution pH of 7.29 for Ca:P ratios of 1:1 to 4:1, an initial solution pH of 7.48 for Ca:P ratios of 5:1 to 8:1, and an initial solution pH of 7.91 for Ca:P ratios of 9:1 to 12:1. In contrast, as shown in FIG. 2b, the permeate treated in the second set of examples had an initial solution pH of 7.20 for all Ca:P molar ratios (i.e., 2:1, 4:1, 6:1, 8:1, and 10:1), which is lower than the lowest pH (i.e., 7.29) of the first set of experiments.

Thus, as evidenced by these trials, phosphorous removal efficiency is influenced by the initial solution pH, with lower removal efficiencies observed at lower pH values and higher removal efficiencies at higher pH values. Additionally, as shown by comparison of the initial and final pH of these samples, a higher initial pH of the solution seems to allow alkaline pH conditions to be reached more easily, thus favoring precipitation to occur, while the permeate solutions with a lower initial pH showed little to no variation in pH after coagulant was added, and also showed negligible phosphorous removal (despite a supersaturated solution after coagulant addition).

### Example 3—Use of a Pure Coagulant (Calcium Oxide)

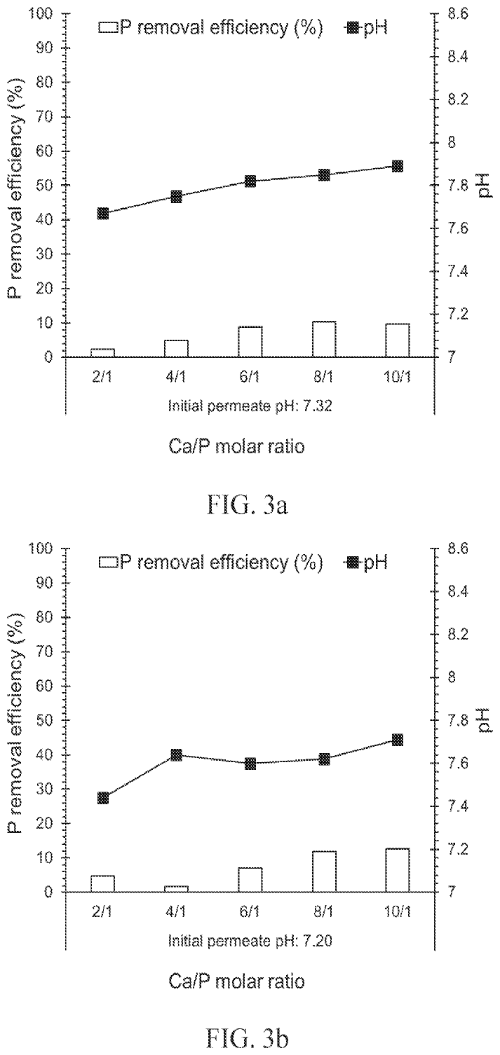

Another set of experiments similar to those described in Example 2 were performed but using a pure coagulant including 100 percent calcium oxide (CaO). Two sets of trials were conducted, and the results, in terms of phosphorous removal efficiency and final pH, are summarized in FIGS. 3a and 3b. FIGS. 3a and 3b also show the initial permeate pH for each set of samples.

Although the final pH of the solutions were slightly higher than was achieved with the mixed coagulant (i.e., 50:50 CaO/CaCl₂ mixture) described in Example 2, the final pH remained below 8. As shown in FIGS. 3a and 3b, there was improvement in the phosphorous removal efficiency at the lower Ca:P doses compared to the CaO/CaCl₂ mixture experiments. This demonstrates that the buffering capacity of the solution resists pH increases to alkaline conditions ideal for phosphorus precipitation, thereby compromising overall phosphorous removal.

The swine wastewater permeate tested in Examples 2 and 3 had a total alkalinity in the range of from 1660 to 3300 mg/L CaCO₃. This likely contributed by the presence of high concentrations of carbonate/bicarbonate and ammonia. Carbonate alkalinity can effect the amount of calcium phosphate precipitated in wastewater nutrient recovery systems, as well as the dose requirements, phosphorous removal efficiency, and potentially the quality of the final recovered product.

### Example 4—Treatment of Liquid Permeate Prior to Coagulation to Enhance Nutrient Recovery

Another set of experiments were performed as described in Examples 2 and 3, but with a pH adjustment and stripping step of the swine wastewater permeate prior to addition of the coagulant. In these trials, the characteristics of the permeate were altered to remove the carbonate alkalinity from the permeate solution prior to addition of the coagulant using a two-step process. First, the pH of each of the permeate samples was reduced by adding concentrated sulfuric acid (H₂SO₄). The addition of this acid was effective to convert bicarbonate alkalinity to carbonic acid (H₂CO₃), which is a weak. unstable acid. After the pH adjustment step, the resulting permeate liquid was aerated overnight to strip the CO₂ gas (generated by decomposition of the carbonic acid) out of the solution. The total alkalinity was then measured after overnight aeration to confirm the effectiveness of permeate alteration in removing alkalinity. Specific details of this procedure are discussed in detail below and with regard to the referenced Figures.

As discussed above, samples of swine wastewater permeate (as discussed in Example 1) were treated with concentrated (18 M) sulfuric acid. The pH-adjusted permeate was then mixed to promote reaction, and the mixture was aerated overnight with a stream of air passed through the solution to strip any carbon dioxide gas from the solution. The pH-adjusted, aerated permeate had a final pH of 5.5 and a total alkalinity of 69 mg/L CaCO₃, which marks a reduction of nearly 97 percent from the liquid permeate measured prior to the pH adjustment.

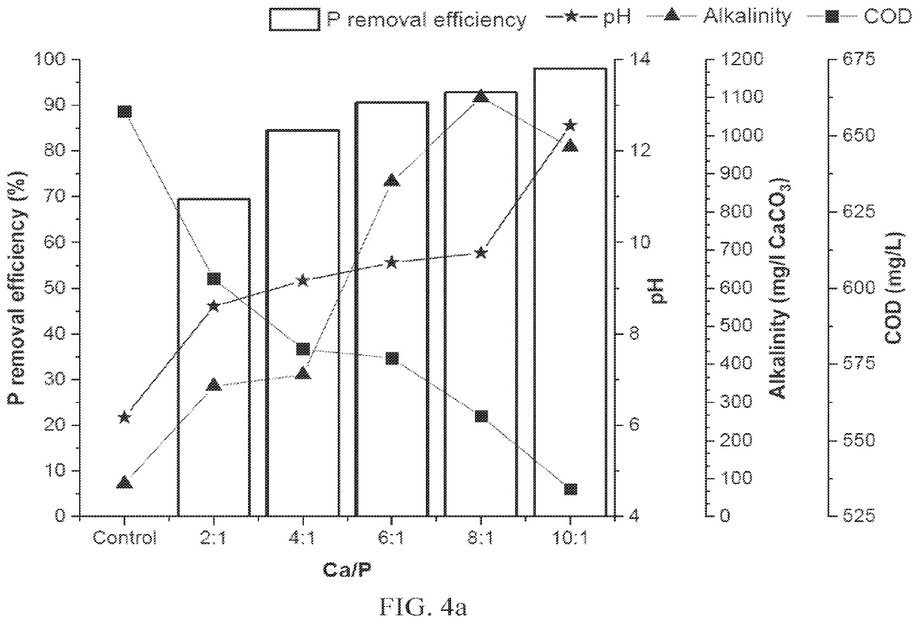

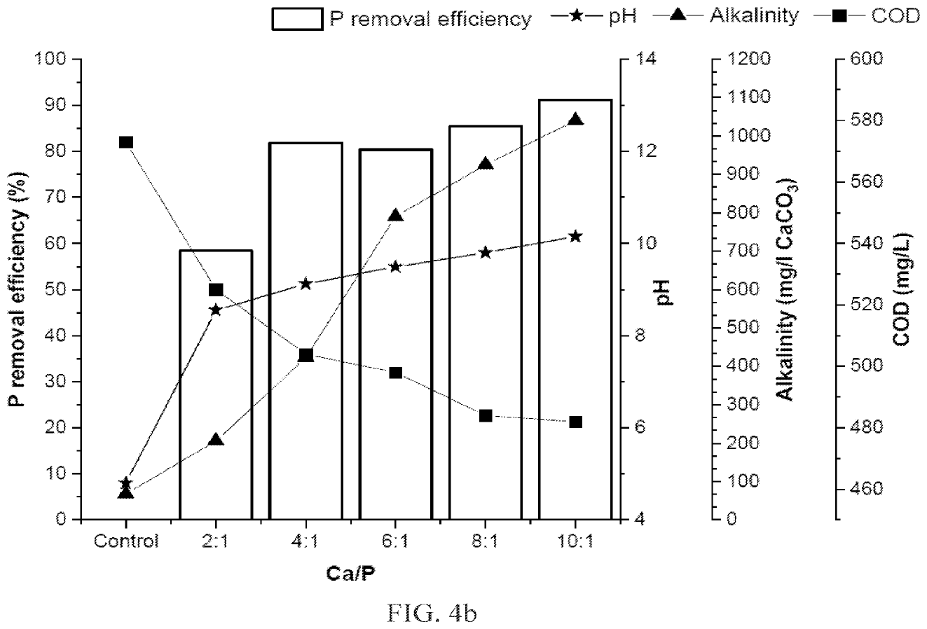

The pH-adjusted, aerated permeate was then subjected to a solids recovery step as described in Examples 2 and 3. That is, different amounts of coagulant were added to achieve final Ca:P ratios of 2:1, 4:1, 6:1, 8:1, and 10:1. The coagulant used in these trials was pure calcium oxide, which increased the pH of the solutions to 8 or more upon addition. FIGS. 4a and 4b show duplicate runs of these experiments, and report the phosphorous removal efficiency, as well as the initial and final pH, alkalinity, and COD (in mg/L) for each run, as well as the control to which no coagulant was added ceteris paribus.

As shown in FIG. 4a, the phosphorus removal efficiency increased with increasing Ca:P ratios (e.g., increased amounts of CaO coagulant added). The highest phosphorous removal shown in FIG. 4a (i.e., 97%) was achieved at the highest Ca:P ratio tested (i.e., 10:1). The residual phosphorus concentration in the residual liquid permeate stream remaining after separation of the solids was around 1.35 mg P/L.

As compared to phosphorous removal efficiencies achieved with unaltered permeate streams (as described in Examples 2 and 3 and shown in FIGS. 2a,b and 3a,b), the experiments described in this Example demonstrated a significant improvement. The phosphorus removal efficiencies in the pH regulated and aerated permeate described in this Example far exceeded the removal efficiencies achieved with unaltered permeate described in Examples 2 and 3, particularly at lower Ca/P ratios (e.g., less than 5:1). For instance, at a Ca:P ratio of 2:1, a phosphate removal efficiency of almost 70 percent (as shown in FIG. 4a) was achieved, as compared to a 15 percent removal efficiency achieved using unaltered (i.e., not pH adjusted and not aerated) permeate. Similarly, at a Ca:P ratio of 4:1, the phosphorous removal efficiency in the pH-altered, aerated permeate was 83 percent, as shown in FIG. 4a, while the in the unaltered permeate tested in Example 3 at the same Ca:P ratio only exhibited a 36 percent removal efficiency. It can be concluded from the data provided herein that improved phosphorous removal efficiency is related to solution pH, which ranged from 8.6 for a Ca:P ratio of 2:1 to a pH of 12.5 for a Ca:P ratio of 10:1. This is shown graphically in FIGS. 4a.

Additionally, as shown in FIG. 4a, the maximum phosphorous removal efficiency of 97percent was achieved at a Ca:P ratio of 10:1 with a pH-adjusted, aerated swine wastewater permeate. Additionally, the pH adjusted, aerated permeate exhibited a COD removal of up to about 18 percent when treated with an increasing dose of calcium oxide (i.e., larger Ca:P ratios), as shown in FIG. 4a.

Although not wishing to be bound by theory, it is hypothesized that the loss of carbonate alkalinity in the pH regulated aerated permeate resulted in higher availability of the Ca²⁺ ions to participate in phosphate precipitation reactions. Additionally, the buffering capacity of the altered permeate is significantly reduced in the absence of carbonate alkalinity, making it easier for calcium oxide to reach alkaline conditions.

As discussed previously, a second, duplicate set of experiments was conducted with another sample of permeate and similar coagulant additions. The results are shown in FIG. 4b. As shown in FIG. 4b, the phosphorous removal efficiency trends (i.e., how it changes with Ca:P ratio) were similar for this second set of trials, although the maximum phosphorous removal at the 10:1 Ca:P ratio was slightly lower at 91 percent. The difference in absolute values of the phosphorous removal efficiency between the two replicate runs is likely due to the dynamic variability in the composition of the swine wastewater permeate. Overall, the results achieved demonstrate the effectiveness of this method of permeate alteration in removing carbonate alkalinity prior to phosphorus capture in order to maximize beneficial phosphorous removal and recovery.

### Example 5—Testing & Characterization of Recovered Nutrient Products (RNPs)

Semi-solid nutrient-rich samples obtained from swine wastewater processes as described in Examples 2-4 were characterized for phosphorous content, citric acid (CA) solubility, and X-Ray diffraction (XRD) analysis. The original samples were freeze-dried and digested using the EPA3051A method in a microwave digestion unit. The freeze-dried products were analyzed for the total phosphorous according to the procedure described in Zarcinas, B. A., McLaughlin, M. J., & Smart, M. K. (1996), “The effect of acid digestion technique on the performance of nebulization systems used in inductively coupled plasma spectrometry.” Communications in Soil Science and Plant Analysis, 27(5-8), 1331-1354, which was then modified to use a digestion block instead of a microwave using an Inductively Coupled Plasma Optical Emission Spectrometer (ICP-OES, Varian 720-ES, Santa Clara, CA). Calcium content in the final products was also analyzed in the ICP-OES using the same processed samples used for phosphorous analysis. A powder X-ray Diffraction (XRD) analysis of freeze-dried products was conducted using a PANalytical Empyrean Multi-Purpose X-Ray Diffractometer (Spectris Company, Egham, Surrey, UK) with a copper anode material and generator settings of 35 cV and 20 mA. Solubility tests using 2% (w/v) citric acid were conducted using a modified method used by the Association of Official Agricultural Chemists (Chemists, A. o. O. A., & Lepper, H. A. (1945), Official methods of analysis) for the freeze-dried products.

Several solid samples recovered from the testing performed in Examples 2 and 4 were analyzed to characterize the phosphorus content, as well as to quantify other properties that correlate to a sample's suitability as fertilizers—namely, solubility in citric acid. The total phosphorous content in various samples and corresponding citric acid solubility results are summarized in Table 4, below.

TABLE 4
Total P content and citric acid solubility of recovered
nutrient products from different types of swine permeate

| | | Ca:P | | | Ca:P molar | 2% Citric acid |
|---|---|---|---|---|---|---|
| Permeate | Coagulant | molar | Total P | Ca | ratio in final | solubility |
| type | type | ratio | (wt %) | (wt %) | product | (% of total P) |
| Unaltered | CaO/CaCl₂ | 4:1 | 8.6 | 53.2 | 4.8 | 2.3 |
| swine | (50/50) | 5:1 | 7.7 | 60.3 | 6.1 | 2.7 |
| permeate | mixture | 6:1 | 6.8 | 22.3 | 2.5 | 2.9 |
| (Ex. 2) | | 7:1 | 5.3 | 40.6 | 5.9 | 3.9 |
| | | 8:1 | 5.8 | 41.1 | 5.5 | 3.5 |
| pH-altered | CaO | 2:1 | 11.8 | 21.1 | 1.4 | 10.9 |
| aerated swine | | 4:1 | 10.9 | 23 | 1.6 | 11.4 |
| permeate | | 6:1 | 11.2 | 24.4 | 1.7 | 9.3 |
| (Ex. 4) | | 8:1 | 10.6 | 21.7 | 1.6 | 10.4 |
| | | 10:1 | 7.5 | 18.6 | 1.9 | 2.1 |

As shown in Table 4, the total phosphorous content of 8.6% (19.7% as P₂O₅) of the recovered nutrient product (RNP) formed by treating the unaltered swine permeate to a 4:1 Ca:P ratio was higher than the phosphorous content of the sample formed using a Ca:P ratio of 8:1 (5.8%). This is despite the fact that the 8:1 Ca:P ratio sample had a very high phosphorous removal efficiency as compared to the 4:1 Ca:P. This data illustrates that higher phosphorous removal efficiencies do not necessarily translate to higher amounts of phosphorous (P content) of the RNPs. Additionally, the citric acid solubility (measured in a 2% solution) of the RNPs formed from unaltered swine wastewater permeate was in the range of 2.3 to 3.9 (% of Total P), while the calcium content was also very high compared to the phosphorus content. As a result, the Ca:P molar ratio in the recovered products was generally higher than the theoretical ratio of hydroxyapatite (HAP) 1.67.

Further analyses comparing the quality and phosphorous content of the solid phase nutrient products recovered from the altered swine permeate solutions were conducted, and the results are also summarized in Table 4. The recovered nutrient products (RNPs) from the altered permeate appeared to be amorphous in nature. As shown in Table 4, the total phosphorous content of the RNPs obtained from the altered permeate samples was higher than those obtained from unaltered permeate samples, with the highest value of 11.8 percent phosphorous (27% P₂O₅) being obtained from a solution treated with coagulant at a Ca:P ratio of 2:1.

Further, as also shown in Table 4, at a coagulant dose sufficient to provide a Ca:P ratio of 4:1, the phosphorous content in the RNP from altered permeate was 10.9% compared to the 8.6% in the RNP obtained from an unaltered permeate treated with a coagulant at a 4:1 Ca:P ratio.

After determining the phosphorous content and Ca:P molar ratios in the RNPs, the citric acid solubility for each was also determined as an indicator of potential agronomic value of these products. The citric acid solubility for all Ca:P ratios (except a Ca:P ratio of 10:1) was in the range of 9.3% to 11.4% (solubility as a % of total phosphorous). As a reference, other agricultural products have higher citric acid solubilities. For example, soft rock phosphate has a 2% citric acid solubility of 30 percent, and triple superphosphate (TSP) has a citric acid solubility of 88 percent of total phosphorous. (See, Christiansen, N. H., Sorensen, P., Labouriau, R., Christensen, B. T., & Ruback, G. H. (2020), “Characterizing phosphorus availability in waste products by chemical extractions and plant uptake,” Journal of Plant Nutrition and Soil Science, 183(4), 416-428.)

Different factors such as crystallinity of the products and the substitution of ions such as Al and Fe may affect the 2% citric acid solubility (See Braithwaite, A., Eaton, A., & Groom, P, 1990,“Factors affecting the solubility of phosphate rock residues in 2% citric acid and 2% formic acid,” Fertilizer research, 23(1), 37-42.) The amorphous nature of the RNPs tested in this Example suggests that this could have better P dissolution and greater plant P bioavailability and uptake. These RNPs are a good candidate for direct fertilizer application depending on soil and crop types.

Further, as shown in Table 4, the solubility of RNPs recovered from altered permeate (i.e., pH-treated and aerated permeate) were about two times higher than the solubilities of RNPs recovered from unaltered permeate (i.e., precipitated directly from the AnMBR).

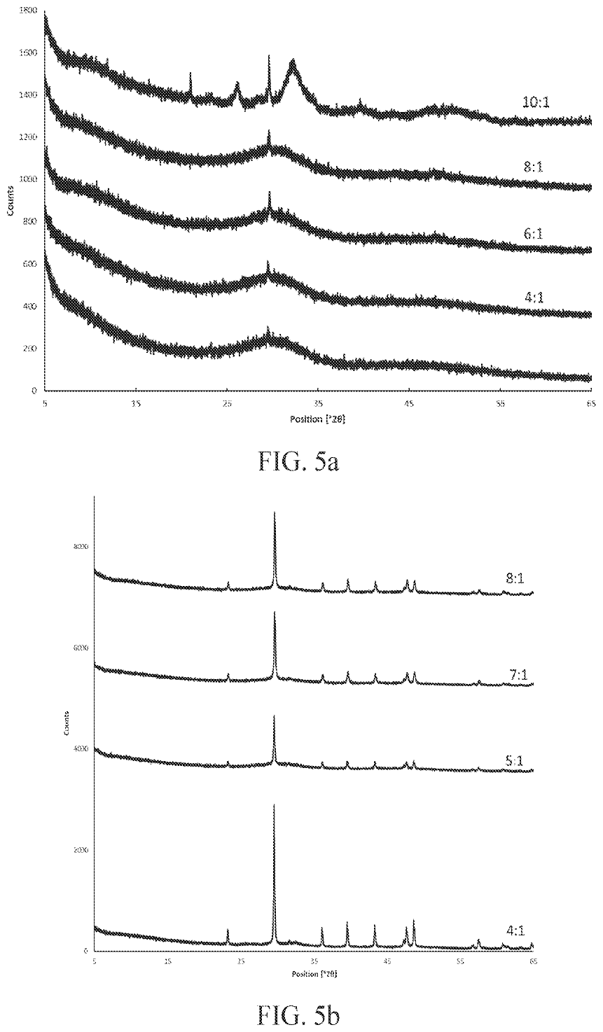

XRD analysis was also performed for phase identification of the precipitates and the results are shown in FIGS. 5a and 5b. Referring initially to FIG. 5a, the XRD patterns of the products obtained from different Ca:P molar ratios ranging from 2:1 to 10:1 were mostly similar to one another and none had clear, distinct peaks. Thus, the products formed were non-crystalline and amorphous. In addition, the XRD results shown in FIG. 5a show no clear calcite peaks in the recovered nutrient product (RNP) obtained from the adjusted (i.e., pH-adjusted and aerated) permeate. Correlation of the phosphorous content reported in Table 4 with the XRD patterns shown in FIG. 5a lead to the conclusion that the precipitates contain amorphous calcium phosphate. The XRD patterns of products from all Ca:P doses tested had a broad peak between 25° and 35° 2θ position, which is associated with the amorphous phosphorous phase as reported in previous studies (See, for example, Daneshgar, S., Buttafava, A., Capsoni, D., Callegari, A., & Capodaglio, A. G., 2018, “Impact of pH and Ionic Molar Ratios on Phosphorous Forms Precipitation and Recovery from Different Wastewater Sludges,” Resources, 7(4), 71; and Dorozhkin, S. V., 2010, “Amorphous calcium (ortho) phosphates,” Acta Biomaterialia, 6(12), 4457-4475.) It is also to be noted that this broad amorphous phosphorous peak in the XRD analysis was not observed for RNPs recovered from the unaltered permeate under any condition.

As shown in FIG. 5a, at a Ca:P ratio of 2:1, the phosphorous content was highest and the XRD pattern showed no clear relevant peaks for the formation of either hydroxyapatite or calcite in the final RNP. This is related to the phosphorous content in the products, as shown in Table 4, where the product quality (in terms of phosphorous content) is higher at lower Ca:P ratios and includes amorphous calcium phosphate as the main product phase. Amorphous calcium phosphate is considered to be one of the most common precursor phases for the formation of crystalline hydroxyapatite (HAP) and is thermodynamically less stable than the latter (Barat, Bouzas, Marti, Ferrer, & Seco, 2009). The amorphous calcium phosphate transforms to crystalline hydroxyapatite with sufficient nucleation induction time (See, Li, X., Xu, Y., Shen, S., Guo, T., Dai, H., & Lu, X, 2022, “Effects of dissolved organic matter on phosphorus recovery via hydroxyapatite crystallization: New insights based on induction time,” Sci Total Environ, 822, 153618.)

Additionally, RNPs recovered from unaltered swine wastewater permeate using Ca:P ratios of 4:1, 5:1, 7:1, and 8:1 were subjected to phase analysis by XRD and the patterns are provided in FIG. 5b. As shown in FIG. 5b, the XRD patterns for these RNPs showed distinct peaks representing the calcite (CaCO₃) mineral, but there were no identifiable peaks representing any type of calcium phosphate mineral, such as hydroxyapatite (HAP). Instead, the presence of clear calcite peaks (marked with a “C” in FIG. 5b) indicate that carbonate ions in the permeate likely formed calcium phosphate minerals, thereby increasing the increase the amount of calcium required to achieve low residual phosphorus concentrations in the treated water. However, XRD analysis of the RNPs recovered from pH altered, aerated swine permeate had weaker, broad, and wider peaks, indicating the absence of this calcite formation and the presence of hydroxyapatite (marked with “Hap” in FIG. 5a).

### Example 6—Characterization of Residual Liquid Permeate after Solids Recovery

Characterization of the residual liquid remaining after flocculation and recovery of the solid nutrients from the altered (i.e., pH altered and aerated) permeate revealed additional chemical oxygen demand (COD) reduction as a result of flocculation, with increasing COD reduction occurring at higher calcium doses.

The AnMBR system used in these trials achieves greater than 80% COD reduction and almost 95% BOD₅ (5-day biochemical oxygen demand) reduction under steady state operation conditions. The permeate withdrawn from the AnMBR was free of suspended organic matter. Thus, any remaining soluble organic content in the permeate is likely to include poorly bioavailable dissolved organic matter (DOM) including humic-like substances and amino acid substances.

As shown in FIG. 4a, the COD was reduced by almost 19% from 658 mg/L in the Control sample to 534 mg/L at a Ca:P molar ratio of 10:1. Similarly, 16% reduction in COD was observed in the second set of experiments with the same Ca:P molar ratio of 10:1, as shown in FIG. 4b. Thus, the total COD reduction efficiency for the entire process (including both the AnMBR and the nutrient recovery steps) is around 98 percent (i.e., 80 percent at the reactor and about 18 percent in the nutrient recovery step), which is superior to any COD reduction achieved to date.

In order to understand the nature of the organic compounds removed from the altered (i.e., pH altered, aerated) permeate during coagulation (resulting in the additional COD reduction during flocculation), fluorometry based EEMS characterization of the supernatant permeate samples collected after sludge settling was performed as follows: Permeate samples collected after coagulation experiments involving the pH altered swine permeate were scanned in quartz cuvettes (Starna 3-Q-10, Ilford, UK) and analyzed using a Horiba Aqualog fluorometer (Horiba, Kyoto, Japan) to generate excitation-emission matrices (EEMs). Interpretation of the EEMs was done by visual identification of the fluorescent peaks. EEM spectra were composed of four peaks commonly found in wastewaters and include: Peak B representing tyrosine-like fluorescence (Ex: 275 nm, Em: 310 nm), Peak T representing tryptophan-like fluorescence (Ex: 275 nm, Em: 340 nm), Peak C representing Humic-like fluorescence (Ex: 300-360 nm, Em: 420-460 nm), and Peak A representing fulvic-like fluorescence (Ex: 230-260 nm, Em: 400-500 nm). (See, for example, Coble, P. G., 2007, “Marine optical biogeochemistry: the chemistry of ocean color,” Chemical reviews, 107(2), 402-418.)

The EEM results, for residual liquid permeates created by treating an altered permeate with Ca:P ratios of 2:1, 4:1, 6:1, 8:1, and 10:1, are summarized in Table 5.

TABLE 5
EEM Data for Altered Swine Wastewater
Permeate at Varying Ca:P Ratios

| | Peak B | % Tyrosine | Peak T | % Tryptophan |
|---|---|---|---|---|
| Ca:P molar | Tyrosine | intensity | Tryptophan | intensity |
| ratio | Intensity** | reduction | Intensity** | reduction |
| Control* | 0.29 | — | 0.32 | — |
| 2:1 | 0.27 | 7.66 | 0.29 | 10.15 |
| 4:1 | 0.25 | 14.68 | 0.27 | 14.66 |
| 6:1 | 0.23 | 19.11 | 0.26 | 16.83 |
| 8:1 | 0.22 | 23.43 | 0.26 | 17.56 |
| 10:1 | 0.11 | 60.66 | 0.22 | 29.39 |

*Fresh permeate prior to coagulant addition
**Raman Intensity Units

The peak intensities for three visually identified peaks (Peak B, Peak T, and Peak C representing tyrosine, tryptophan, and humic like materials, respectively) were analyzed. The results summarized in Table 5 above show that with increasing calcium dosage, there was a greater removal in the fluorescence of tyrosine (Peak B) and tryptophan (Peak T). Further, at the highest Ca:P ratio (i.e., 10:1), the tyrosine-like fluorescence showed a reduction of about 60 percent, and the tryptophan-like fluorescence achieved a reduction of about 30 percent, as compared to the control. Qualitatively, these reductions provide correlated to the observed reduction in COD after coagulation in the residual liquid permeate.

### Definitions

As used herein, the term “altered permeate” refers to a liquid permeate stream withdrawn from a wastewater bioreactor or other similar vessel or zone that has been subjected to a pH-altering step and/or an aeration/stripping step prior to the addition of a coagulant.

As used herein, the term “unaltered permeate” refers to a liquid permeate stream withdrawn from a wastewater bioreactor or other similar vessel or zone to which a coagulant is added. The unaltered permeate has not been subjected to a pH-altering step or an aeration/stripping step prior to the coagulant addition.

As used herein, the terms “a,” “an,” and “the” mean one or more.

As used herein, the term “and/or,” when used in a list of two or more items, means that any one of the listed items can be employed by itself or any combination of two or more of the listed items can be employed. For example, if a composition is described as containing components A, B, and/or C, the composition can contain A alone: B alone; C alone; A and B in combination; A and C in combination, B and C in combination; or A, B, and C in combination.

As used herein, the terms “comprising,” “comprises,” and “comprise” are open-ended transition terms used to transition from a subject recited before the term to one or more elements recited after the term, where the element or elements listed after the transition term are not necessarily the only elements that make up the subject.

As used herein, the terms “having,” “has,” and “have” have the same open-ended meaning as “comprising,” “comprises,” and “comprise” provided above.

As used herein, the terms “including,” “include,” and “included” have the same open-ended meaning as “comprising,” “comprises,” and “comprise” provided above.

As used herein, the phrase “at least a portion” includes at least a portion and up to and including the entire amount or time period.

### Claims not Limited to Disclosed Embodiments

The preferred forms of the invention described above are to be used as illustration only and should not be used in a limiting sense to interpret the scope of the present invention. Modifications to the exemplary embodiments, set forth above, could be readily made by those skilled in the art without departing from the spirit of the present invention.

The inventors hereby state their intent to rely on the Doctrine of Equivalents to determine and assess the reasonably fair scope of the present invention as it pertains to any apparatus not materially departing from but outside the literal scope of the invention as set forth in the following claims.

1. A method for recovering phosphorous-containing product from a wastewater stream, the method comprising:
(a) treating the wastewater stream in a membrane bioreactor to provide a phosphorous-containing liquid permeate stream;
(b) adjusting the pH of at least a portion of the phosphorous-containing liquid permeate stream in a pH adjustment zone to provide a pH adjusted liquid permeate stream;
(c) aerating at least a portion of the pH adjusted liquid permeate stream with a stripping gas in an aeration zone to provide a carbon dioxide containing off-gas stream and an aerated permeate stream; and
(d) precipitating at least one nutrient from the aerated permeate stream in a solids recovery zone to thereby provide a phosphorous-containing recovered nutrient product (RNP) and a residual liquid stream.

2. The method of claim 1, wherein the precipitating of step (d) includes adding at least one calcium-containing coagulant to the aerated permeate stream in the solids recovery zone.

3. The method of claim 2, wherein the aerated permeate stream comprises at least one phosphorous-containing compound, wherein the calcium-containing coagulant is added in an amount sufficient to provide a calcium-to-phosphorous molar ratio of at least 2:1 and/or not more than 20:1 in the solids recovery zone.

4. The method of claim 2, wherein the coagulant comprises calcium oxide.

5. The method of claim 1, further comprising withdrawing a biogas stream from the membrane bioreactor and generating energy with at least a portion of the biogas stream;
and utilizing at least a portion of the energy generated from the biogas stream to perform at least a portion of one or more of steps (b) through (d).

6. The method of claim 1, further comprising contacting at least a portion of the residual liquid stream with a carbon dioxide-containing gas stream in a water treatment zone to provide a treated water stream, and wherein the treated water stream has a pH of at least 6.75 and a chemical oxygen demand (COD) of less than 600 mg/L.

7. The method of claim 6, wherein the carbon dioxide-containing gas stream comprises at least a portion of the carbon dioxide-containing off gas stream withdrawn from the aeration zone.

8. The method of claim 1, wherein the residual liquid stream formed in step (d) has a phosphorous content of not more than 5 mg of phosphorous per L (mg P/L) and wherein the RNP has a total phosphorous content of at least 7.5 weight percent, based on the total weight of the RNP.

9. The method of claim 1, wherein the pH adjusted liquid permeate stream comprises dissolved carbon dioxide, wherein the aerating of step (c) is carried out for an amount of time sufficient to reduce the amount of dissolved carbon dioxide in the pH adjusted liquid permeate by at least about 90 percent, and wherein the aerated permeate stream has a calcium carbonate concentration of no more than 70 mg/L of calcium carbonate.

10. The method of claim 1, wherein the pH adjusted liquid permeate stream formed in step (b) has a pH of not more than 6.

11. The method of claim 10, wherein the adjusting of step (b) is carried out by adding at least one acid to the phosphorous-containing liquid permeate stream, and wherein the acid comprises at least one of sulfuric acid, hydrochloric acid, nitric acid, and phosphoric acid.

12. The method of claim 1, wherein the wastewater stream comprises agricultural wastewater.

13. The method of claim 1, wherein the RNP comprises at least about 75 weight percent of calcium phosphate, based on the total weight of the RNP, wherein the calcium phosphate comprises amorphous calcium phosphate, wherein the RNP comprises less than about 2 weight percent of struvite, and wherein the calcium-to-phosphorous ratio of the RNP is less than 2.5:1.

14. The method of claim 1, wherein the RNP comprises at least 5 weight percent of phosphorous and has a 2% citric acid solubility of at least about 2 percent.

15-20. (canceled)

21. A wastewater processing facility for recovering at least one phosphorous-containing product from a stream of wastewater, the system comprising:
a wastewater source;
an anaerobic membrane bioreactor for processing a stream of wastewater from the wastewater source, the anaerobic membrane bioreactor being in fluid flow communication with the wastewater source and configured to receive the stream of wastewater, wherein the anaerobic membrane bioreactor comprises a membrane configured to permit at least a portion of the wastewater introduced into the anaerobic membrane bioreactor to pass therethrough thereby providing a permeate stream, and wherein the anaerobic membrane bioreactor is configured to discharge at least a portion of the permeate stream from the anaerobic membrane bioreactor;
a pH adjustment zone for altering the pH of the permeate, the pH adjustment zone being in fluid flow communication with the anaerobic membrane bioreactor, wherein the pH adjustment zone is configured to receive the permeate stream and to discharge a pH adjusted permeate stream;
an aeration zone for removing dissolved carbon dioxide from at least a portion of the pH adjusted permeate stream, the aeration zone being in fluid flow communication with the pH adjustment zone, wherein the aeration zone is configured to receive at least a portion of the pH adjusted permeate stream and to discharge an aerated permeate stream, wherein the aeration zone is configured to receive a stripping gas and pass the stripping gas through at least a portion of the pH adjusted permeate stream to remove at least a portion of dissolved carbon dioxide gas therefrom, and wherein the aeriation zone is configured to discharge a carbon dioxide-containing off gas stream therefrom; and
a solids recovery zone for removing one or more nutrient solids from the aerated permeate stream via addition of at least one coagulant, the solids recovery zone being in fluid flow communication with the aeration zone, wherein the solids recovery zone is configured to receive at least a portion of the aerated permeate stream and discharge a residual liquid stream and a phosphorous-containing recovered nutrient product (RNP).

22. The facility of claim 21, wherein the pH adjustment zone and the aeration zone are defined in a single vessel.

23. (canceled)

24. (canceled)

25. The facility of claim 22, further comprising a water treatment zone for further treating the residual liquid stream discharged from the solids recovery zone to provide a treated water stream, wherein the water treatment zone is configured to receive at least a portion of the residual liquid stream and discharge the treated water stream, and wherein the water treatment zone is configured to introduce a carbon dioxide-containing gas stream into the water treatment zone and pass at least a portion of the carbon dioxide-containing gas stream through the residual liquid stream.

26. The facility of claim 25, wherein the aeration zone is in fluid flow communication with the water treatment zone so that at least a portion of the carbon dioxide-containing off gas stream from the aeration zone is introduced with or as the carbon dioxide-containing gas stream into the water treatment zone.

27. A phosphorous-containing composition recovered from a wastewater stream, the phosphorous-containing composition comprising:
at least 50 weight percent of amorphous calcium phosphate, based on the total weight of the phosphorous-containing composition; and
not more than about 5 weight percent of nitrogen or other nutrients originating from a wastewater stream,
wherein the phosphorous-containing composition has each of the following properties (i) through (iv)—(i) a total phosphorous content of at least 5 weight percent;
(ii) a calcium-to-phosphorous molar ratio of less than 2.5;
(iii) a citric acid solubility (in 2% citric acid) of at least 2 weight percent; and
(iv) an XRD pattern that shows no clear calcite peak.

28. The composition of claim 27, wherein the phosphorous-containing composition comprises struvite in an amount of less than 5 weight percent, and wherein the phosphorous-containing composition includes calcium phosphate in the range of from about 75 percent to about 95 percent and has a total phosphorous content in the range of from about 7 to about 14 percent, wherein the phosphorous-containing composition has a calcium-to-phosphorous molar ratio in the range of from about 1.2:1 to about 2.2:1 and a citric acid solubility greater than about 4 percent.

29. (canceled)
